(19) United States
(12) Patent Application Publication
(10) Pub. No.: US 2015/0169642 A1
(43) Pub. Date: Jun. 18, 2015

(54) METHOD AND SYSTEM FOR MAKING INDEX PAGE USING CONTENT AUTHORING TOOL

(71) Applicant: NAVER CORPORATION, Seongnam-Si (KR)

(72) Inventors: Seil HWANG, Seongnam-si (KR); Bo-Hyun KIM, Seongnam-si (KR); Sung-Won CHA, Seongnam-si (KR); Yoon-Sil KANG, Seongnam-si (KR)

(21) Appl. No.: 14/559,455

(22) Filed: Dec. 3, 2014

(30) Foreign Application Priority Data
Dec. 18, 2013 (KR) 10-2013-0158065

(51) Int. Cl. G06F 17/30

(52) U.S. Cl. CPC G06F 17/30268; G06F 17/30867; G06F 17/3087

(57) ABSTRACT

Methods and systems of making an index page for a website are provided. The methods and systems of making an index page include providing an authoring environment, the authoring environment including a set of content pages of the website and a tool for generating the index page for the website; generating the index page by associating a content page selected from the set of content pages with an index of the index page, the selected content page being selected using the tool; and providing the index page based on a request for the website.

### CROSS-REFERENCE TO RELATED APPLICATION

This application claims priority from and the benefit of Korean Patent Application No. 10-2013-0158065, filed on Dec. 18, 2013, which is hereby incorporated by reference in its entirety for all purposes as if fully set forth herein.

### BACKGROUND

1. Field

Example embodiments relate to technology for making a content site for mobile environments.

2. Description of the Background

Currently, a framework and an infrastructural environment for making a content page to be adaptable to a mobile environment have been provided, which enables any user to readily make a mobile content page.

For example, Korean Patent Registration No. 10-0917672, registered on Sep. 9, 2009, discloses a mobile website making tool for providing a tree-based directory structure.

However, a mobile website making tool using a method of configuring an index based on a predetermined layout is being employed to configure an index page of a mobile content site.

In particular, in the case of an existing website making tool, all of a title, an image, and a description of content to be displayed on an index need to be manually input. A content page to be linked to the index needs to be set one by one.

### SUMMARY

At least one example embodiment relates to a method of making an index page for a website.

According to an example embodiment, a method of making an index page for a website includes providing an authoring environment, the authoring environment including a set of content pages of the website and a tool for generating the index page for the website; generating the index page by associating a content page selected from the set of content pages with an index of the index page, the selected content page being selected using the tool; and providing the index page based on a request for the website.

Example embodiments provide that the generating the index page includes generating an image-type index by displaying an image associated with the selected content page in the index.

Example embodiments also provide that the providing the authoring environment includes providing, by the tool, a list of contents, the list of contents including the set of content pages and a template corresponding to the index page.

Example embodiments provide that the template indicates a plurality of unit areas for the index. Example embodiments provide that the selected content page is selected from the list of contents. Example embodiments provide that the generating the index page includes associating the selected content page with a selected one of the plurality of unit areas of the template.

Example embodiments provide that the associating is based on a drag-and-drop command. The drag-and-drop command includes dragging the selected content page to a region that corresponds to the selected one of the plurality of unit areas, and dropping the selected content page within the region.

Example embodiments provide that the generating the index page includes extracting content information from the selected content page; and displaying the extracted content information in the index.

Example embodiments provide that the extracting the content information includes extracting at least one of a (i) title associated with the selected content page, (ii) a description associated with the selected content page, (iii) an image associated with the selected content page, and (iv) metadata associated with the selected content page.

Example embodiments provide that the providing the authoring environment includes editing, using the tool, the extracted content information.

Example embodiments provide that the providing the authoring environment includes editing, using the tool, at least one of (i) a display location of the extracted content information within the index, (ii) a size of the display area, and (iii) a size of the index.

At least one example embodiment relates to a method of making an index page.

According to an example embodiment, a method of making an index page includes providing a list of contents, the list of contents including at a set of content pages, each of the set of content pages include a website and a template corresponding to an index page of the website; associating a content page selected from the set of content pages with a selected one of a plurality of unit areas of an index of the index page, the plurality of a unit areas being provided by the template; extracting content information from the selected content page; generating the index page by associating the extracted content information in the selected unit area of the index; and providing the index page based on a request for the website.

At least one example embodiment relates to a non-transitory computer-readable media that stores program code for controlling a computer system to make an index page of a website, that when loaded into a processor of the computer system, configures the processor to provide a function of controlling a computer system to make an index page of a website.

According to an example embodiment, a non-transitory computer-readable media that stores program code for controlling a computer system to make an index page of a website, that when loaded into a processor of the computer system, configures the processor to provide an authoring environment, the authoring environment including a set of content pages of a website and a tool for generating an index page for the website; generate the index page by associating a content page selected from the set of content pages with an index, the selected content page being selected using the tool; and provide the index page based on a request for the website,.

At least one example embodiment relates to a website management system.

According to an example embodiment, a website management system includes at least one processor configured to provide an authoring environment, the authoring environment including a set of content pages of a website and a tool for generating an index page for the website; generate the index page by associating a content page selected from the set of content pages with an index, the selected content page being selected using the tool; and provide the index page based on a request for the website.

Example embodiments provide that in the generating the index page, the processor is further configured to generate an image-type index by displaying an image associated with the selected content page in the index.

Example embodiments provide that in the providing the authoring environment, the processor is further configured to provide, using the tool, a list of contents, the list of contents including the set of content pages and a template corresponding to the index page.

Example embodiments provide that the template indicates a plurality of unit areas for the index. Example embodiments provide that the selected content page is selected from the list of contents. Example embodiments provide that in the generating the index page, the processor is further configured to associate the selected content page with a selected one of the plurality of unit areas of the template.

Example embodiments provide that in the generating the index page, the processor is further configured to extract content information from the selected content page; and display the extracted content information in the index.

Example embodiments provide that in the extracting the content information, the processor is further configured to extract at least one of a (i) title associated with the selected content page, (ii) a description associated with the selected content page, (iii) an image associated with the selected content page, and (iv) metadata associated with the selected content page.

Example embodiments provide that in the providing the authoring environment, the processor is further configured to edit, using the tool, the extracted content information.

Example embodiments provide that in the providing the authoring environment, the processor is further configured to edit, using the tool, at least one of (i) a display location of the extracted content information within the index, (ii) a size of the display area, and (iii) a size of the index.

At least one example embodiment relates to a website management system.

According to an example embodiment, a website management system includes at least one processor configured to provide a tool for making an index page of a website, the tool provides a list of contents including (i) a set of content pages that constitutes the website and (ii) a template corresponding to the index page; associate a content page selected from the set of content pages selected from the set of content pages with a selected one of a plurality of unit areas of an index of the index page, the plurality of a unit areas being provided by the template; extract content information from the selected content page; generate the index page by associating the extracted content information in the selected unit area of the index; and provide the index page based on a request for the website.

Example embodiments provide that in providing the tool, the processor is configured to edit the extracted content information.

Example embodiments provide that in providing the tool, the processor is configured to edit at least one of (i) a display location of the extracted content information within the index, (ii) a size of the display area, and (iii), a size of the index.

It is to be understood that both the foregoing general description and the following detailed description are explanatory and are intended to provide further explanation of the example embodiments as claimed.

### BRIEF DESCRIPTION OF THE DRAWINGS

The accompanying drawings, which are included to provide a further understanding of the example embodiments and are incorporated in and constitute a part of this specification, illustrate example embodiments, and together with the description serve to explain the principles of the example embodiments.

FIG. 1 illustrates a user terminal and a site management system according to an example embodiment.

FIGS. 2 through 4 illustrate a manager screen for making an index page of a mobile site according to an example embodiment.

FIGS. 5 through 9 illustrate a screen describing a process of making an index page of a mobile site according to an example embodiment.

FIG. 10 is a flowchart illustrating a method of making an index page according to an example embodiment.

FIG. 11 illustrates a configuration of a site management system according to an example embodiment.

FIG. 12 illustrates a configuration of a terminal according to an example embodiment.

### DETAILED DESCRIPTION OF EXAMPLE EMBODIMENTS

The invention is described more fully hereinafter with reference to the accompanying drawings, in which example embodiments are shown. This invention may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and areas may be exaggerated for clarity. Like reference numerals in the drawings denote like elements.

Example embodiments will now be described more fully with reference to the accompanying drawings in which example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and areas are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of areas illustrated herein but are to include deviations in shapes that result, for example, from manufacturing. For example, an implanted area illustrated as a rectangle will, typically, have rounded or curved features and/or a gradient of implant concentration at its edges rather than a binary change from implanted to non-implanted area. Likewise, a buried area formed by implantation may result in some implantation in the area between the buried area and the surface through which the implantation takes place. Thus, the areas illustrated in the figures are schematic in nature and their shapes are not intended to illustrate the actual shape of an area of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described with reference to the accompanying drawings.

The example embodiments relate to a content making platform including a tool that enables a user to make a content page of a corresponding site in order to construct a web/mobile site.

According to example embodiments, it is possible to enhance a convenience in making content by providing an authoring tool capable of automatically making an index page using a pre-made content page of a content site.

Example embodiments may also provide an overall preview in a relatively efficient manner such that the overall preview is performed only with an index page. Example embodiments may also include verifying a portion of content information without switching a page by providing the index page including a list of images with respect to a content site by extracting desired (or alternatively, “predetermined”) information from a pre-made content page, and by displaying the extracted information as index information.

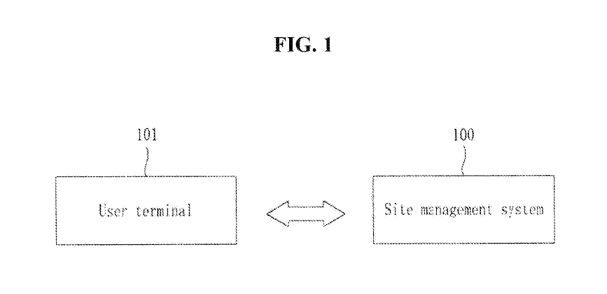

FIG. 1 illustrates a relationship between a user terminal and a site management system according to an example embodiment. FIG. 1 illustrates a site management system 100 and a user terminal 101. Referring to FIG. 1, a line with arrowheads may indicate that data is transmitted and received between the site management system 100 and the user terminal 101 over a wired/wireless network.

The user terminal 101 may refer to any type of terminal devices, for example, a personal computer (PC), a smartphone, and a tablet, accessible to a web/mobile site associated with the site management system 100 or capable of installing and executing a service exclusive application. Here, the user terminal 101 may perform the overall service operation, for example, a service screen configuration, a data input, a data transmission and reception, and a data storage according to a control of the web/mobile site or the exclusive application.

The site management system 100 functions as a platform to construct a website or a mobile site. Hereinafter, a description will be made by using the mobile site as an example. However, an authoring tool according to example embodiments may be applicable to the website as well as the mobile site.

The site management system 100 may provide the authoring tool that enables a user, for example, a general user or an advertiser, to make a content page of the mobile site. In particular, the site management system 100 may provide an authoring environment in which the user is capable of configuring an index page of the mobile site using a content page of the mobile site. In various embodiments, the content page of the mobile site may be a pre-made content page.

The term “index page” used herein may indicate a page that indicates a table of contents for the mobile site or other like directory of the mobile site.

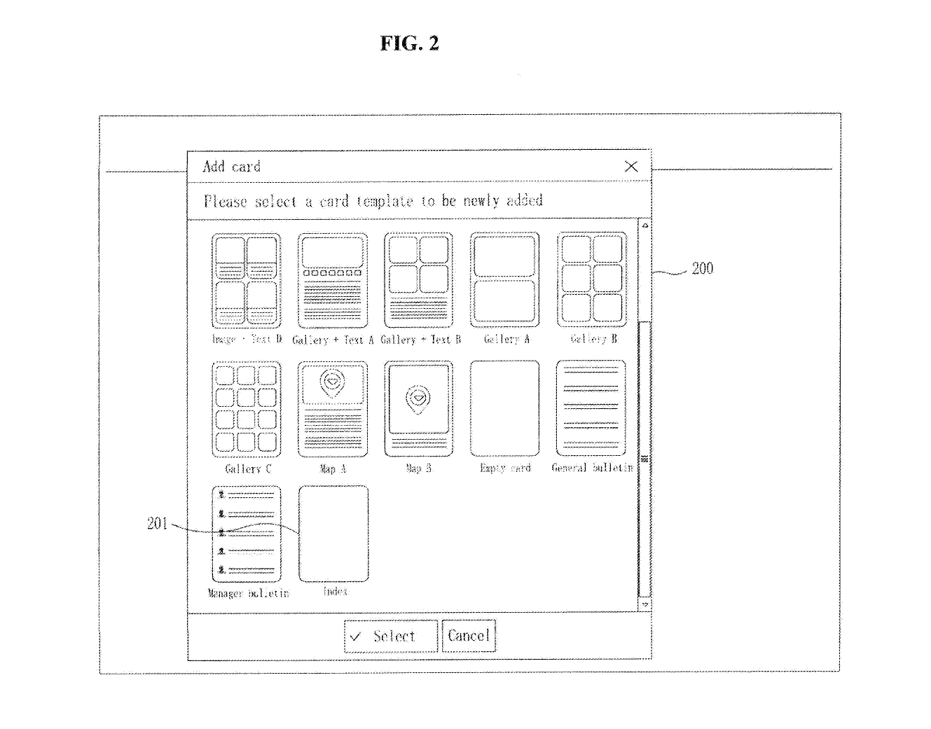

FIGS. 2 through 4 illustrate a manager screen for making an index page of a mobile site according to an example embodiment. FIGS. 2 through 4 illustrate examples of a manager screen displayed on a terminal of a user, for example, a manager that makes and manages a mobile site.

FIG. 2 illustrates a card addition screen 200 for adding an index card according to an example embodiment. A site management system 100 may provide a site format based on, for example, a purpose of a mobile site and/or a type of business of the mobile site. The site management system 100 may provide a card template in a variety of formats, based on a type and/or a usage of content for configuring the content page. The card addition screen 200 may include a list of card templates addable or otherwise adaptable to the content page. According to example embodiments, an ‘index’ card template 201 capable of configuring an index page may be added to a card template list of the card addition screen 200.

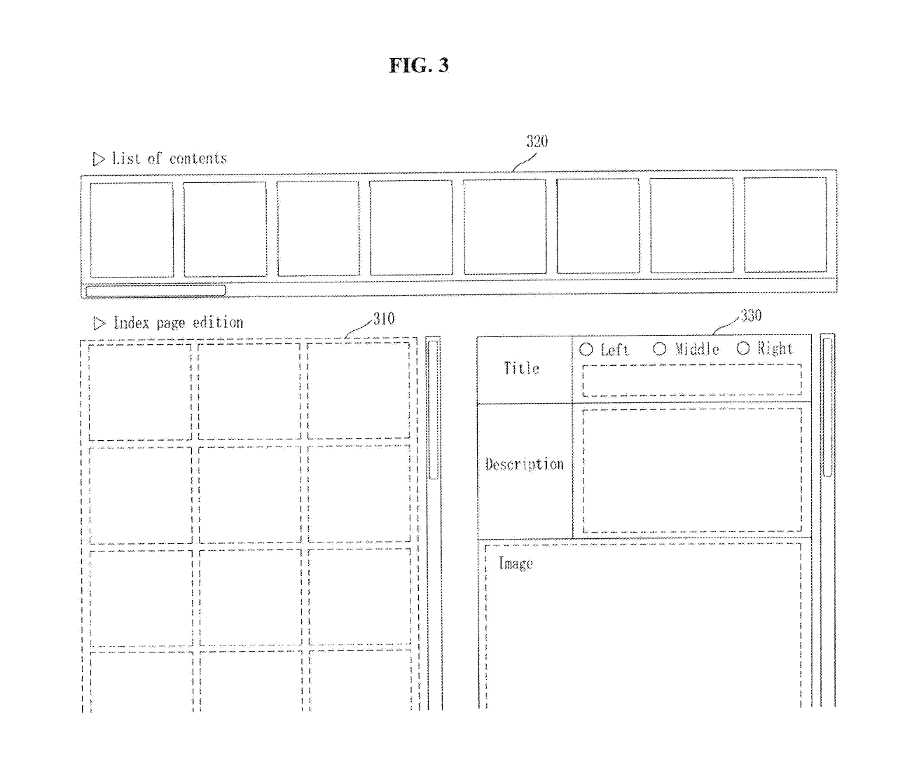

FIG. 3 illustrates an index making screen for making an index page according to an example embodiment. The index making screen may be opened by selecting the ‘index’ card template 201 on the card addition screen 200 of FIG. 2 or through other paths for correcting a pre-made index page. Referring to FIG. 3, the index making screen may include an index edition screen 310, a list of contents 320, and a content edition screen 330.

The index edition screen 310 refers to an area of the index making screen for configuring and editing an index page to be displayed at the mobile site. According to example embodiments, an index page may be provided as an image type list, thumbnails list, icons list, bullet points list, an outline type list, and/or any other like list. To this end, the index edition screen 310 may include a plurality of unit areas, each of which display contents for configuring one or more indices for a mobile site. Each of the plurality of unit areas may correspond to an index page type (e.g., the image type list, thumbnails list, the icons list, the bullet points list, the outline type list, and/or any other like list). Here, a size and a location of a unit area within the index edition screen 310 may be designated for each of the contents for configuring indices for a mobile site and/or index page type. Content for configuring indices for a mobile site and/or an index page type may be displayed in a single unit area or a combination of at least two unit areas among the plurality of unit areas.

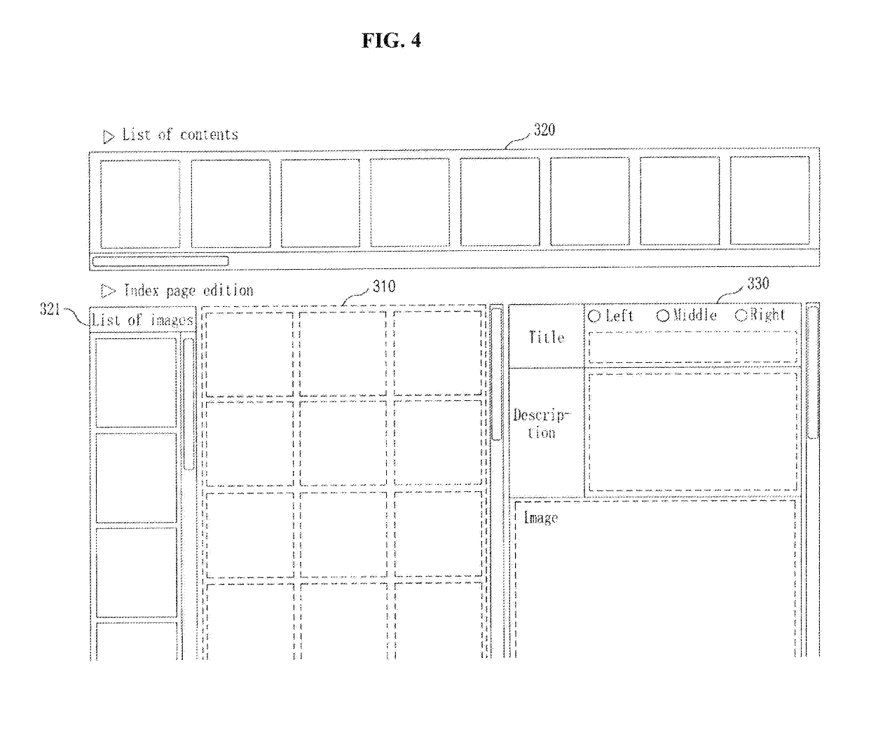

Targets available as contents that configure indices are sorted in the list of contents 320. According to example embodiments, the list of contents 320 may a provided as pre-made content pages when constructing a mobile site of a user. Here, a content page may indicate any type of document(s) made as at least one piece of information, for example, a text, an image, a moving picture, a sound, a map, and/or any other like pieces of information. In various embodiments, a desired type of document(s) among content pages included in the list of contents 320 in addition to the list of contents 320 may be sorted as a separate list and be displayed on the index making screen. For example, referring to FIG. 4, the entire documents may be sorted and displayed on the list of contents 320, and among the content pages included in the list of contents 320, documents made using only images and/or moving pictures may be sorted as a list of images 321, which is then displayed.

The index making screen configured according to the example embodiments described above may provide a drag-and-drop function and/or any other like gesture, operation, or command between the list of contents 320 or the list of images 321 and the index edition screen 310 in order to configure and edit an index. For example, in response to dragging operation, a content page from the list of contents 320 and dropping the content page on the index edition screen 310, the corresponding content page may be included in an index. Also, in response to dragging a content page from the index edition screen 310 and dropping the content page on the list of contents 320, the corresponding content page may be deleted from the index.

The content edition screen 330 refers to an area for automatically displaying desired information of a corresponding content page and editing the displayed information in response to designating the content page selected from the list of contents 320 or the list of images 310 to a unit area of the index edition screen 310. According to example embodiments, a title, a description, an image, metadata, and/or other like information extracted from a content page may be separately displayed on the content edition screen 330 in a correctable and/or editable form.

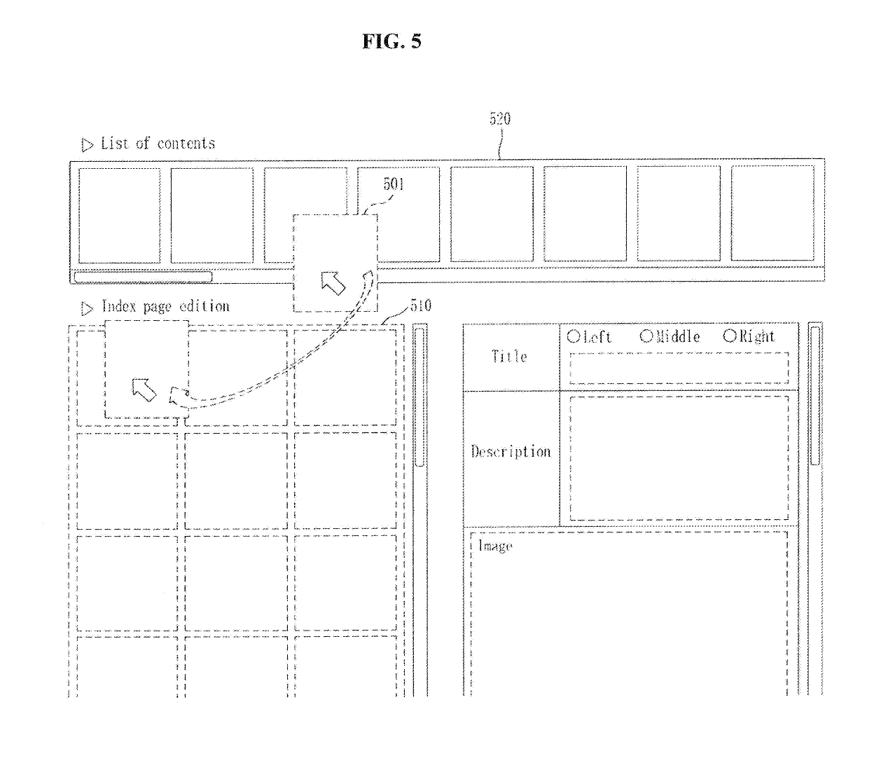

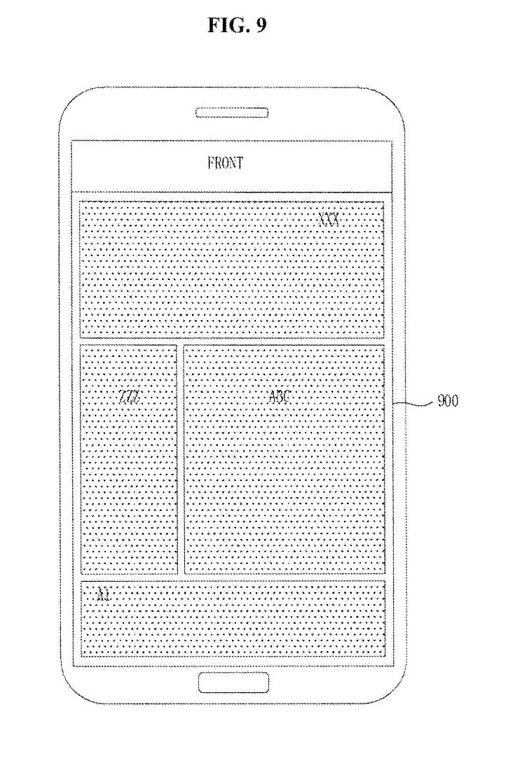

FIGS. 5 through 9 illustrate a screen showing a process of making an index page of a mobile site according to an example embodiment.

Referring to FIG. 5, a user may select, from a list of contents 520, a content page 501 desired to be added to an index page, and may drag the content page 501 and drop the content page 501 on an index edition screen 510.

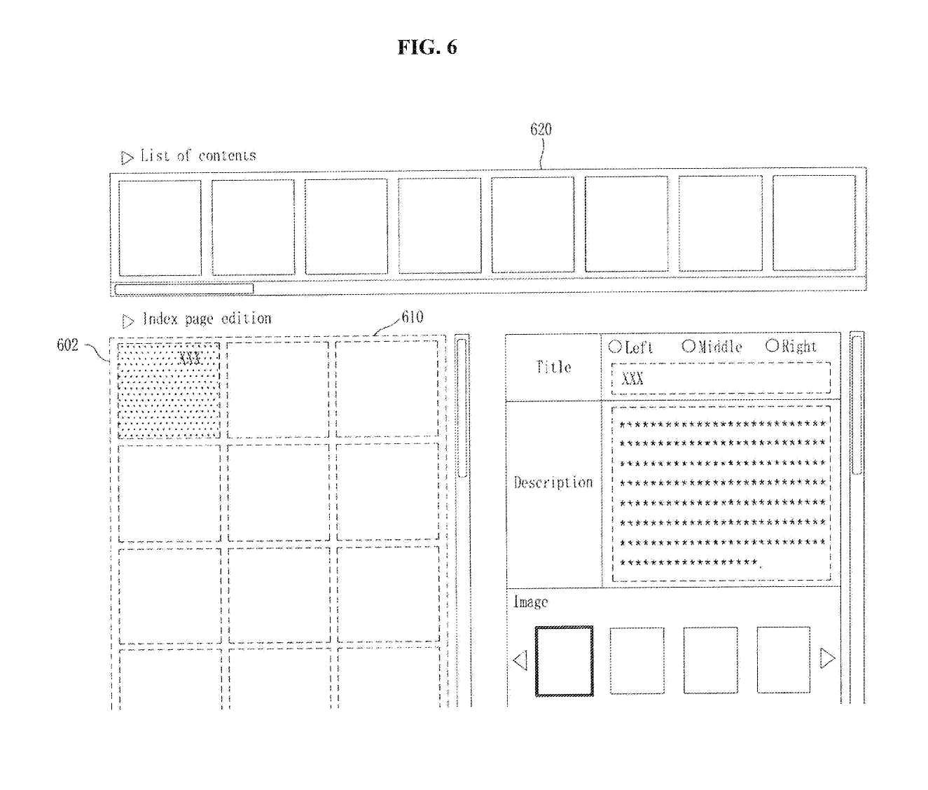

Referring to FIG. 6, in response to dragging a content page from a list of contents 620 and dropping the content page on an index edition screen 610, a portion of information (hereinafter, content information) 602 included in the content page may be displayed on a unit area corresponding to a drop location. Here, the content information 602 may include at least one of a title, a description, an image or a moving picture, metadata, or other like information included in the content page, as information extracted from the content page. According to example embodiments, when at least one image is included in a content page, an image may be displayed on a unit area corresponding to a drop location. According to example embodiments, in the case of a document in which a content page is made using only a text, a portion of the document, for example, a first paragraph may be displayed on a unit area corresponding to a drop location. Here, when only the text is displayed on the unit area of the index edition screen 610, a background color may be applied to the corresponding area.

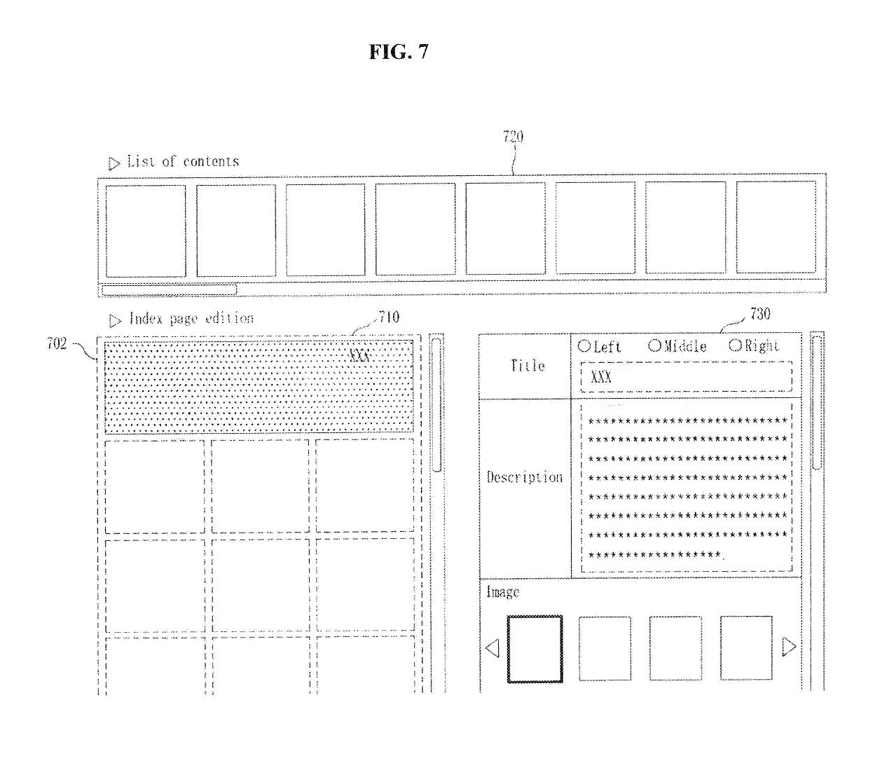

According to various embodiments, a user may edit a size and a location of an area for displaying content information on the index edition screen 610. According to example embodiments, the user may change a location of a display area by dragging and dropping content information displayed on a unit area within the index edition screen 610. In various embodiments, the user may change a display location of content information from a unit area corresponding to an initial drop location to a unit area corresponding to another location. According to example embodiments, the user may change a size of an area on which content information is displayed by changing the aspect ratio of content information displayed on the unit area of the index edition screen 610. For example, the user may edit a size of content information 602 displayed on a single unit area of FIG. 6 to be a size of an area on which content information 702 is displayed as illustrated in FIG. 7 by increasing the aspect ratio of the content information 602.

In addition, referring to FIG. 7, when a content page is dragged from a list of contents 720 and dropped on an index edition screen 710 and thereby designated to an index, desired information of the content page, for example, a title, a description, an image, metadata, and/or other like information extracted from the content page may be displayed on a content edition screen 730. Here, the user may change a title or a location, for example, the left, the right, and/or the middle of the title displayed on the index through the content edition screen 730. In various embodiments, the user may also edit a detailed description of content displayed on the index, on the content edition screen 730. Also, when a plurality of images is included in the content page, a list of images may be displayed through the content edition screen 730. The user may select an image of the content to be displayed on the index from the list of images and may replace an existing image with the selected image. As shown in FIG. 7, a currently applied image may be highlighted on the list of images of the content edition screen 730.

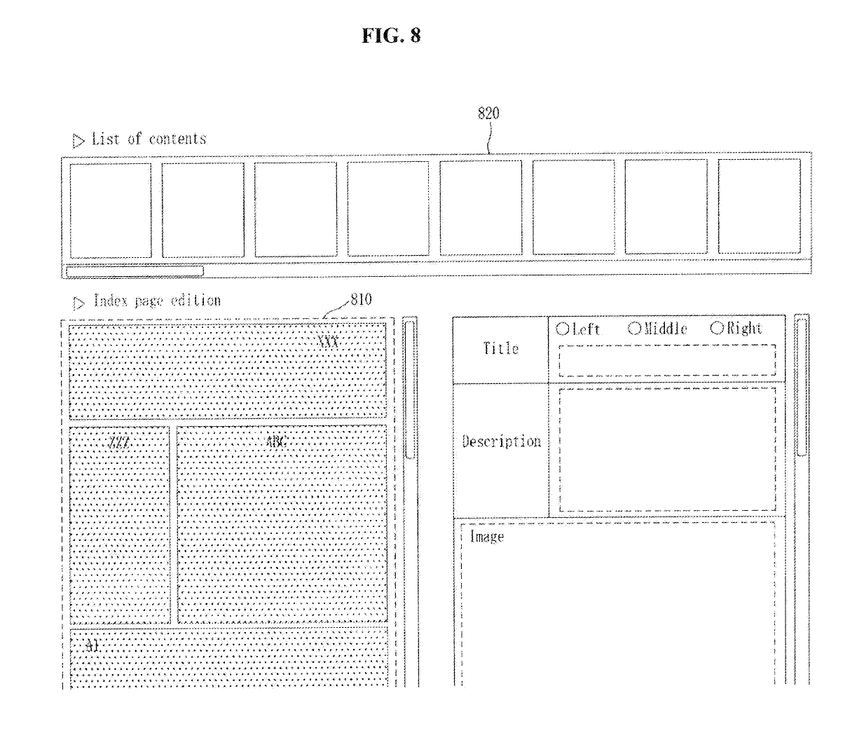

Referring to FIG. 8, by repeating the above process, the user may make an index page and conveniently set a content page to be linked to an index by selecting a pre-made content page from a list of contents 820 and by readily configuring the entire area of an index edition screen 810. In an example in which an index page includes four content pages titled with “XXX”, “ZZZ”, “ABC”, and “A1” as illustrated in FIG. 8, an index page 900 made by a user using an authoring tool may be displayed as a front screen or a main screen of a corresponding mobile site in response to a user's request for access to the mobile site through a mobile terminal. Here, in response to a selection on an index of the index page 900, relevant content may be provided. For example, in response to a selection of an index of desired content included in the index page 900, a user may directly navigate to a content page designated and/or corresponding to the index. In various embodiments, when the user selects the index of the desired content including in the index page 900, the user may navigate to the content page designated or corresponding to the index through a link after the link is displayed on the index page 900.

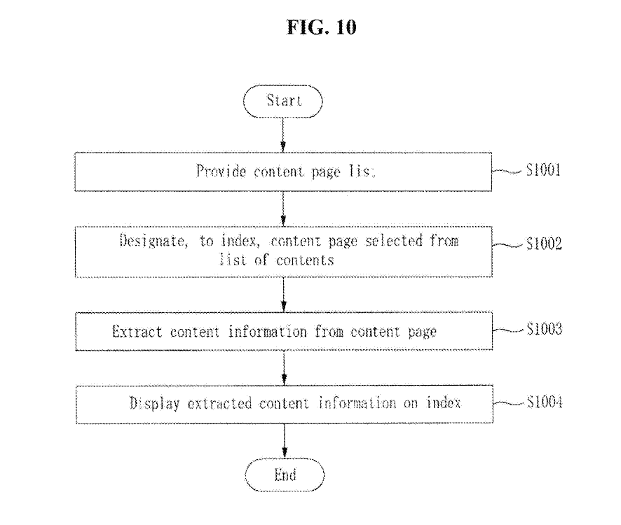

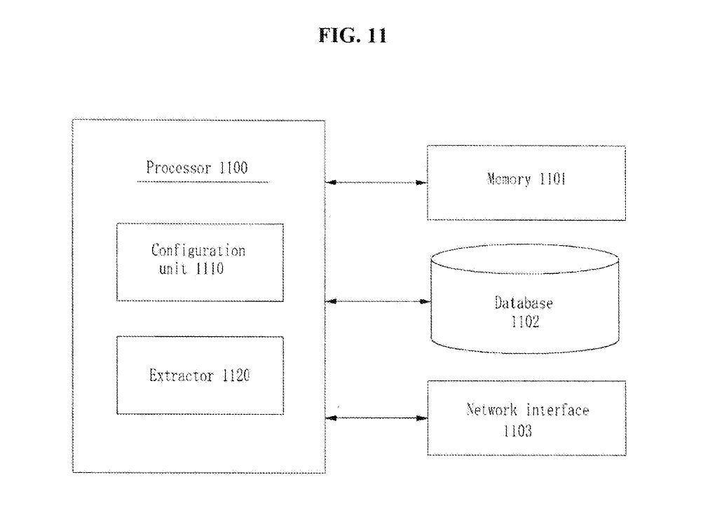

FIG. 10 is a flowchart illustrating a method of making an index page according to an example embodiment. Operations of the index page making method of FIG. 10 may be performed by a site management system 100 described above with reference to FIG. 1 and described below with reference to FIG. 11.

In operation S1001, the site management system 100 provides a content page list. In various embodiments, the site management system 100 provides an authoring tool for making an index page in response to a request from a user. In such embodiments, the authoring tool may include the content page list. For example, a list of contents may be pre-made at a mobile site of the user using an authoring tool. Here, the authoring tool may provide an index card template capable of configuring an image type index page and provide a drag-and-drop function between the list of contents and the index card template.

In operation S1002, the site management system 100 designates, to an index, a content page selected from the list of contents. In various embodiments, when the user drags the content page selected from the list of contents and drops the content page on the index card template, the site management system 100 may designate the corresponding content page to an index corresponding to a drop location.

In operation S1003, the site management system 100 extracts desired information from the content page. In various embodiments, content information of the content page may be selected from the list of contents. In such embodiments, the site management system 100 may extract a title, a description, an image, metadata, and/or other like information from the content page designated to the index in response to a selection of the user.

In operation S1004, the site management system 100 displays the extracted content information on the corresponding index with respect to the content page designated to the index.

Further, according to various embodiments, the authoring tool may provide a function of editing content information displayed on an index and/or a function of editing a location and/or a size of the index on which the content information is displayed.

In various embodiments, the index page making method may include a reduced number of operations or additional operations based on the detailed description made above with reference to FIGS. 1 through 9. Also, at least two operations may be combined and/or an order or locations of one or more of the above-described operations may be changed.

The methods according to example embodiments may be recorded in non-transitory computer-readable media as program code to be carried out through a variety of computer systems and/or hardware devices.

Program code according to example embodiments may be configured as a PC-based program or an application exclusive for a mobile terminal A site management application (App) according to example embodiments may be configured in an independently operating program form or in an in-app form of a desired application to be operable on the desired application.

FIG. 11 illustrates a configuration of the site management system 100 according to an example embodiment. Referring to FIG. 11, the site management system may include a processor 1100 including a configuration unit 1110 and an extractor 1120, a memory 1101, a database 1102, and a network interface 1103.

Program code and/or software modules including an authoring tool for making an index page and instructions to make the index page using the authoring tool may be stored in the memory 1101. Memory 1101 is a hardware device configured to store program code for one or more operating systems and/or program code for one or more software components. The program code for the authoring tool provided from the site management system 100 and program code for the index page making processes performed by the site management system 100, described above with reference to FIGS. 1 through 9, may be stored in the memory 1101. For example, the memory 1101 may be a hard disc, a solid state disk (SSD), a secure digital (SD) card, and/or other like storage media capable of storing and recording data. The program code may be loaded into the processor 1100, and once the program code is loaded into the processor 1101, the processor 1101 may be programmed to perform the program code, thereby transforming the processor 1101 into a special purpose processor. The program code and/or software components may also be loaded from a separate computer readable storage medium into memory 1101 using a drive mechanism (not shown). Such separate computer readable storage medium may include a magnetic disc, DVD/CD-ROM/Blu-ray drive, memory card, USB flash drive, memory stick, and/or other like computer readable storage medium (not shown). In some embodiments, software components may be loaded into memory 1101 via network interface 1103, rather than via a computer readable storage medium.

The database 1102 is associated with one or more data storage devices capable of storing and maintaining information required to create a mobile site and to make an index page of the mobile site. A content page pre-made at the mobile site of the user and content linked to the content page may be stored in the database 1102. The data storage device(s) may include at least one of a primary storage device, a secondary storage device, a tertiary storage device, a non-linear storage device, and/or other like data storage devices. Furthermore, database 1102 may include one or more virtual machines, such that the physical data storage devices containing database 1102 may be logically divided into multiple virtual data storage devices and/or databases. In various embodiments, database 1102 may reside on one physical hardware data storage device, or may reside one multiple physical data storage devices.

Network interface 1103 is a computer hardware component that connects site management system 100 to a computer network. Network interface 1103 may connect site management system 100 to the computer network via a wired or wireless connection. The network interface 1103 may be coupled with the site management system 100 in order to communicate with user terminals and/or mobile devices, which use an authoring tool for creating a mobile site and making an index page for the mobile site.

The processor 1100 refers to an apparatus configured to execute program code according to a command of a program stored in the memory 1101. As discussed above, once the program code for the authoring tool and the program code for the index page making processes are loaded into the processor 1101, the processor 1101 may be programmed to perform the program code, thereby transforming the processor 1101 into special purpose processor(s). The processor 1100 may be a microprocessor, such as a central processing unit (CPU) or another like device that is configured to carryout arithmetic, logical, and input/output operations according to the program code. A detailed configuration of the processor 1100 will be described as follows.

The configuration unit 1110 may provide an authoring tool for configuring an index page of a mobile site. According to example embodiments, the configuration unit 1110 may provide an authoring tool for configuring an index page as an image type list, a thumbnails list, an icons list, a bullet points list, an outline type list, and/or any other like list. As described above with reference to FIGS. 2 through 8, the authoring tool may support an environment and functions for configuring an index page of a mobile site using a pre-made content page of the mobile site.

The configuration unit 1110 may provide, as a list of contents, pre-made content pages that are developed using the authoring tool. When the user selects a content page from the list of contents and provides the selected content page from the list of contents to the content page on an index card template, the content page may be designated to an index corresponding to a drop location.

The extractor 1120 may extract content information from the content page designated to the index. According to example embodiments, the extractor 1120 may extract a title, a description, an image, metadata, and/or other like information from the content page.

The configuration unit 1110 may display, on the index, content information, for example, the title, the description, the image, and/or the metadata extracted from the content page.

In various embodiments, the configuration unit 1110 may provide a function for editing the content information using the authoring tool, and may apply a description edited by the user to the content information displayed on the index.

In various embodiments, the configuration unit 1110 may provide a function for editing at least one of a size and a location of an area for displaying content information on an index using the authoring tool. In such embodiments, the configuration unit 1110 may change a location of the index on which the content information is displayed or a size of the index on which the content information is displayed based on a description edited by the user.

A portion of constituent elements and/or components included in the site management system 100 may be omitted, or the site management system 100 may further include additional constituent elements and/or components. Also, at least two constituent elements and/or components may be combined and/or an order of operation between constituent elements and/or components may be changed.

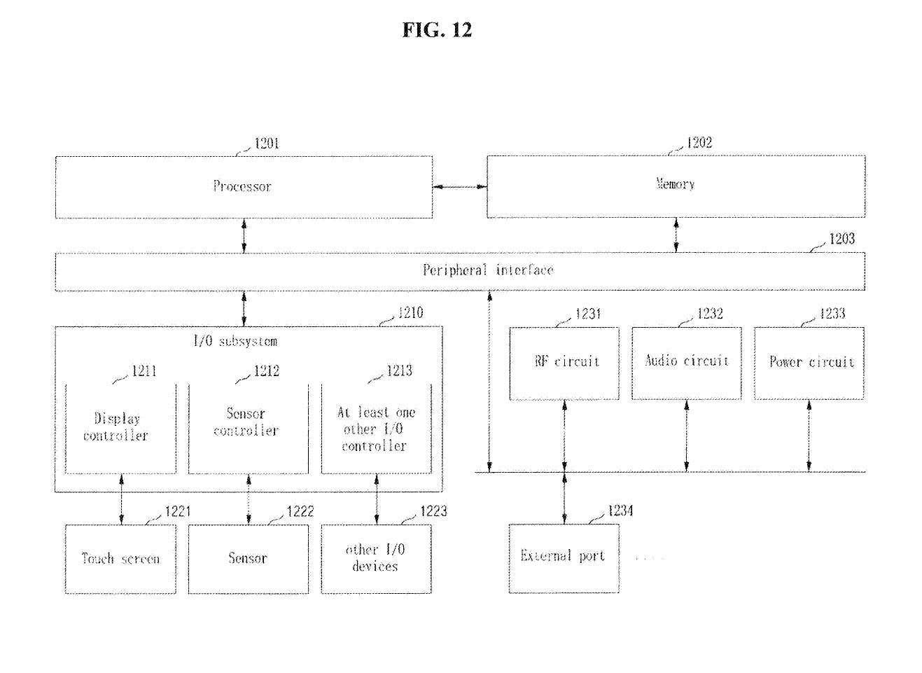

FIG. 12 illustrates a configuration of a terminal 101 according to example embodiments.

Referring to FIG. 12, the terminal 101 may include at least one processor 1201, a memory 1202, a peripheral interface 1203, an input/output (I/O) subsystem 1210, a touch screen 1221, a sensor 1222, other I/O devices 1223, a radio frequency (RF) circuit 1231, an audio circuit 1232, a power circuit 1233, and an external port 1234. Such components may communicate through at least one communication bus or signal line.

The terminal of FIG. 12 is only an example and thus, may include a more or fewer components than the components illustrated in FIG. 12. Alternatively, the terminal may combine two or more components and/or include different components than those depicted in FIG. 12. The components of FIG. 12 may be configured as hardware devices including an integrated circuit specified for processing at least one signal or an application, software, or a combination of hardware and software.

The memory 1202 is a hardware device configured to store program code for one or more operating systems and/or program code for one or more software components such as the units and/or modules as discussed above. The memory 1202 may include, for example, a high-speed random access memory, a magnetic disk, a static random access memory (SRAM), a dynamic RAM (DRAM), a read only memory (ROM), a flash memory, a non-volatile memory, and/or other like data storage mechanism capable of storing and recording data. The memory 1202 may record and/or store one or more software modules required for an operation of the terminal, one or more sets of instructions, and/or other varieties of data. In various embodiments, the program code and/or software components may also be loaded from a separate computer readable storage medium into memory 1202 using a drive mechanism (not shown). Such separate computer readable storage medium may include a memory card, USB flash drive, memory stick, and/or other like computer readable storage medium (not shown). In some embodiments, software components may be loaded into memory 1202 via external port 1234, rather than via a computer readable storage medium. Additionally, an access from another component such as the processor 1201 and the peripheral interface 1203 to the memory 1202 may be controlled by the processor 1201.

The peripheral interface 1203 may combine an I/O peripheral device of the terminal with the at least one processor 1201 and the memory 1202. The processor 1201 may perform a variety of functions for the terminal and may process data by executing one or more software modules, firmware, middleware, microcode, hardware description languages, and/or any other like set of instructions stored in the memory 1202. When implemented in software, the program the at least one processor 1201 may be programmed to perform the program code or code segments. Once the program code and/or software modules are loaded into the processor 1201, the processor 1201 may be programmed to perform the program code and/or software modules, thereby transforming the processor 1201 into a special purpose processor.

. The RF circuit 1231 is a hardware device that may transmit and receive an RF signal known and/or other like electromagnetic signals. The RF circuit 1231 may convert an electrical signal to an electromagnetic signal and/or may convert the electromagnetic signal to the electrical signal in order to communicate with a communications network and/or a communication apparatus using the electromagnetic signal. The RF circuit 1231 may include an antenna system, an RF transceiver, at least one amplifier, a tuner, at least one oscillator, a digital signal processor a CODEC chipset, a subscriber identification module (SIM) card, a memory, and/or other like components. The RF circuit 1231 may communicate with a cellular phone network, a wireless network such as a WLAN and/or metropolitan area network (MAN), an Internet network such as an intranet and/or World Wide Web (WWW), and other apparatuses, through wireless communication. The wireless communication may include Global System for Mobile Communications (GSM), Enhanced Data GSM Environment (EDGE), wideband code division multiple access (WCDMA), code division multiple access (CDMA), time division multiple access (TDMA), Bluetooth, Wireless Fidelity (Wi-Fi) such as the Institute of Electrical and Electronics Engineers (IEEE) 802.11a, IEEE 802.11b, IEEE 802.11g, and/or IEEE 802.11n, voice over Internet Protocol (VoIP), Wi-MAX, Long Term Evolution (LTE), an email protocol such as Internet Message Access Protocol (IMAP) and/or Post Office Protocol (POP), an instance messaging such as eXtensible Messaging and Presence Protocol (XMPP), Session Initiation Protocol for Instant Messaging and Presence Leveraging Extensions (SIMPLE), Instant Messaging and Presence Service (IMPS), and Short Message Service (SMS), or any other like communication protocols. Also, the wireless communication may employ a plurality of communication standards, protocols, and technologies, without being limited to the above examples.

The audio circuit 1232 may provide an audio interface between the user and the terminal 101 via a speaker, a microphone, or other like acoustic-to-electric sensor. The audio circuit 1232 may receive audio data from the peripheral interface 1203, may convert the audio data to an electrical signal, and may transmit the electrical signal to the speaker. The speaker may convert the electrical signal to a human-audible sound wave. The audio circuit 1232 may also receive an electrical signal converted from a sound wave by the microphone. The audio circuit 1232 may convert the electrical signal to the audio data, and may transmit the audio data to the peripheral interface 1203 for processing. The audio data may be retrieved from the memory 1202 or the RF circuit 1231, or may be transmitted thereto through the peripheral interface 1203. According to example embodiments, the audio circuit 1232 may further include a headset jack or other like connection interface. The headset jack may provide, for example, an interface between the audio circuit 1232 and a mobile audio I/O peripheral device such as a headset including both output and input or an output exclusive headphone. In some embodiments, a mobile audio I/O peripheral device may be connected to the audio circuit 1232 via a Bluetooth connection or other like wireless protocol.

The power circuit 1233 may supply power to all of or a portion of the components included in the terminal 101. For example, the power circuit 1233 may include a power management system, at least one power source such as a battery and alternating current (AC), a charging system, a power failure detection circuit, a power converter or inverter, a power state indicator, and other components for power generation, management, and distribution.

The I/O subsystem 1210 is a hardware device that provides an interface between peripheral devices and the processor 1201. The I/O subsystem 1210 may combine the peripheral interface 1203 with the I/O peripheral device such as the touch screen 1221, the sensor 1222, and the other I/O devices 1223. The I/O subsystem 1210 may include a display controller 1211, a sensor controller 1212, or at least one other I/O controller 1213. According to example embodiments, the touch screen 1221, the sensor 1222, or the other I/O device 1223 may be combined with the peripheral interface 1203 without using the I/O subsystem 1210.

According to example embodiments, at least one of the processor 1201, the peripheral interface 1203, and the I/O subsystem 1210 may be formed on a single chip. Alternatively, a portion of at least one of the processor 1201, the peripheral interface 1203, and the I/O subsystem 1210 may be formed on a single chip.

The display controller 1211 is a hardware device that controls the production and display of video, graphics, or other like visual output. The display controller 1211 may receive an electrical signal from the touch screen 1221 including a touch sensing area, may transmit an electrical signal to the touch screen 1221, or may perform both transmission and reception of an electrical signal. The touch screen 1221 may display a visual output for the user according to a control of the display controller 1211. The visual output may include graphics, a text, an icon, a video, and a combination thereof (hereinafter, collectively referred to as “graphics”). According to an example embodiment, a portion of or all of the visual output may correspond to a user interface described as follows.

The touch screen 1221 may utilize a liquid crystal display (LCD) technology, a light emitting polymer display (LPD) technology, an organic light emitting diode (OLED) technology, and/or an active-matrix organic light emitting diode (AMOLED) technology. Although a LCD technology, LPD technology, an OLED technology, or AMOLED technology may be employed for the touch screen 1221, example embodiments are not limited thereto and thus, other display technologies may be applicable. Also, although the touch screen 1221 and the display controller 1211 may use a capacitive technology, a resistive technology, an infrared (IR) technology, and a surface acoustic wave technology, example embodiments are not limited thereto and any technology already known or to be developed in the future may be employed. Also, the touch screen 1221 and the display controller 1211 may detect a contact or a desired (or alternatively “predetermined”) movement or release of the contact using other constituent elements for determining at least one contact point with a proximity sensor array or the touch screen 1221.

The display controller 1211 may be combined with a screen not including a touch sensing area. The screen not including the touch sensing area may receive an electrical signal from the display controller 1211 and may display the visual output for the user. Although a plasma display panel (PDP) technology, an electronic pager display (EPD) technology, an LCD technology, an LPD technology, an OLED technology, or an AMOLED technology may be employed for the screen not including the touch sensing area, other display technologies may also be employed. The terminal 101 using the screen not including the touch sensing area may provide an I/O device, such as a physical keyboard, a mouse, and one or more physical buttons, as a user interface for an operation.

At least one other I/O controller 1213 may receive an electrical signal from the other I/O devices 1223 or may transmit an electrical signal thereto. The other I/O devices 1223 may include, for example, a button, a keyboard, a touch pad, a dial, a slider switch, and a joystick. Also, the at least one other I/O controller 1213 may be combined with any of pointer devices such as an IR port, a universal serial bus (USB) port, and a mouse.

According to example embodiments, the other I/O devices 1223 may include at least one physical button or virtual button. In the case of the virtual button, a button may be a portion of the touch screen 1221 and a button controller may be a portion of the display controller 1211. According to example embodiments, the button may include an up/down button, a locker button, or a push button for controlling a volume of the speaker or the microphone. As an example, in response to a short push of the user on the push button, the touch screen 1221 may be locked and a process of unlocking a device may be initiated by applying a gesture on the touch screen 1221. In some embodiments, the user may turn a power of the terminal 101 on or off by applying a long push to the push button.

According to example embodiments, the other I/O devices 1223 may include at least one physical keyboard or virtual soft keyboard. As an example of a keyboard, a symbol of standard configuration (QWERTY) and/or non-standard configuration may be employed. In the virtual soft keyboard, a soft keyboard may be a portion of the touch screen 1221 and a soft keyboard controller may be a portion of the display controller 1211. An example of the soft keyboard may include the number of graphics or the number of soft keys less than the number of keys included in the physical board. Accordingly, the user may select at least one graphics of the soft keyboard and may display corresponding at least one symbol on the touch screen 1221.

According to example embodiments, the other I/O devices 1223 may include a touch pad for activating or inactivating a predetermined function. The touch pad may include a touch sensing area on which a visual output is not displayed. Also, the touch pad may be a portion of a touch sensing surface separate from the touch screen 1221 or may be a portion of a touch sensing surface extended from the touch screen 1221.

As described above, according to example embodiments, it is possible to enhance a convenience in making content by providing an authoring tool capable of automatically making an index page using a pre-made content page of a content site. According to example embodiments, it is possible to provide an efficiency capable of performing the overall preview only with an index page and verifying a portion of content information without switching a page by providing the index page including a list of images with respect to a content site, by extracting desired information from a pre-made content page, and by displaying the extracted information as index information.

The units and/or modules described herein may be implemented using hardware components, software components, or a combination thereof. For example, a processing device may be implemented using one or more processors, a controller and an arithmetic logic unit, a digital signal processor, a microcomputer, a field programmable array, a programmable logic unit, a microprocessor, and/or any other device capable of performing arithmetic, logical, and/or input/output operations by responding to and executing instructions in a defined manner The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, program code, an instruction, software modules, or any combination thereof, for independently or collectively instructing or configuring the processing device to operate as desired special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording media.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD-ROM, DVD, and Blue-ray disks; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. A method of making an index page for a website, the method comprising:
providing, by a processor, an authoring environment, the authoring environment including a set of content pages of the website and a tool for generating the index page for the website;
generating, by the processor, the index page by associating a content page selected from the set of content pages with an index of the index page, the selected content page being selected using the tool; and
providing, by the processor, the index page based on a request for the website.

2. The method of claim 1, wherein the generating the index page comprises:
generating an image-type index by displaying an image associated with the selected content page in the index.

3. The method of claim 1, wherein the providing the authoring environment comprises:
providing, by the tool, a list of contents, the list of contents including the set of content pages and a template corresponding to the index page.

4. The method of claim 3, wherein the template indicates a plurality of unit areas for the index, the selected content page is selected from the list of contents, and the generating the index page comprises:
associating the selected content page with a selected one of the plurality of unit areas of the template.

5. The method of claim 4, wherein the associating is based on a drag-and-drop command, the drag-and-drop command including,
dragging the selected content page to a region that corresponds to the selected one of the plurality of unit areas, and
dropping the selected content page within the region.

6. The method of claim 1, wherein the generating the index page comprises:
extracting content information from the selected content page; and
displaying the extracted content information in the index.

7. The method of claim 6, wherein the extracting the content information comprises:
extracting at least one of a (i) title associated with the selected content page, (ii) a description associated with the selected content page, (iii) an image associated with the selected content page, and (iv) metadata associated with the selected content page.

8. The method of claim 6, wherein the providing the authoring environment comprises:
editing, using the tool, the extracted content information.

9. The method of claim 6, wherein the providing the authoring environment comprises:
editing, using the tool, at least one of (i) a display location of the extracted content information within the index, (ii) a size of the display area, and (iii) a size of the index.

10. A method of making an index page, the method comprising:
providing, by a processor, a list of contents, the list of contents including at a set of content pages, each of the set of content pages include a website and a template corresponding to an index page of the website;
associating, by the processor, a content page selected from the set of content pages with a selected one of a plurality of unit areas of an index of the index page, the plurality of a unit areas being provided by the template;
extracting, by the processor, content information from the selected content page;
generating, by the processor, the index page by associating the extracted content information in the selected unit area of the index; and
providing, by the processor, the index page based on a request for the website.

11. A non-transitory computer-readable media storing program code for controlling a computer system to make an index page of a website, the program code, when loaded into a processor of the computer system, configures the processor to:
provide an authoring environment, the authoring environment including a set of content pages of a website and a tool for generating an index page for the website;
generate the index page by associating a content page selected from the set of content pages with an index, the selected content page being selected using the tool; and
provide the index page based on a request for the website.

12. A website management system, comprising:
at least one processor configured to,
provide an authoring environment, the authoring environment including a set of content pages of a website and a tool for generating an index page for the website;
generate the index page by associating a content page selected from the set of content pages with an index, the selected content page being selected using the tool; and
provide the index page based on a request for the website.

13. The website management system of claim 12, wherein in the generating the index page, the processor is further configured to:
generate an image-type index by displaying an image associated with the selected content page in the index.

14. The website management system of claim 12, wherein in the providing the authoring environment, the processor is further configured to:
provide, using the tool, a list of contents, the list of contents including the set of content pages and a template corresponding to the index page.

15. The website management system of claim 14, wherein the template indicates a plurality of unit areas for the index, the selected content page is selected from the list of contents, and in the generating the index page, the processor is further configured to:
associate the selected content page with a selected one of the plurality of unit areas of the template.

16. The website management system of claim 12, wherein in the generating the index page, the processor is further configured to:
extract content information from the selected content page; and
display the extracted content information in the index.

17. The website management system of claim 16, wherein in the extracting the content information, the processor is further configured to:
extract at least one of a (i) title associated with the selected content page, (ii) a description associated with the selected content page, (iii) an image associated with the selected content page, and (iv) metadata associated with the selected content page.

18. The website management system of claim 16, wherein in the providing the authoring environment, the processor is further configured to:
edit, using the tool, the extracted content information.

19. The website management system of claim 6, wherein in the providing the authoring environment, the processor is further configured to:
edit, using the tool, at least one of (i) a display location of the extracted content information within the index, (ii) a size of the display area, and (iii) a size of the index.

20. A website management system, comprising:
at least one processor configured to,
provide a tool for making an index page of a website, the tool provides a list of contents including (i) a set of content pages that constitutes the website and (ii) a template corresponding to the index page;
associate a content page selected from the set of content pages with a selected one of a plurality of unit areas of an index of the index page, the plurality of a unit areas being provided by the template;
extract content information from the selected content page;
generate the index page by associating the extracted content information in the selected unit area of the index; and
provide the index page based on a request for the website.

21. The website management system of claim 12, wherein in providing the tool, the processor is configured to edit the extracted content information.

22. The website management system of claim 12, wherein in providing the tool, the processor is configured to:
edit at least one of (i) a display location of the extracted content information within the index, (ii) a size of the display area, and (iii), a size of the index.
